(19) United States
(12) Patent Application Publication
(10) Pub. No.: US 2023/0091386 A1
(43) Pub. Date: Mar. 23, 2023

(54) AUGMENTED REALITY HOLOGRAM VIRTUAL AQUARIUM SYSTEM

(71) Applicant: MULTICS CO., LTD., Daejeon (KR)

(72) Inventor: Seungsu YU, Daejeon (KR)

(21) Appl. No.: 17/478,349

(22) Filed: Sep. 17, 2021

(51) Int. Cl. G06T 19/20; G06K 9/00; G06T 7/20; G06F 3/01; G10L 15/00; G10L 15/22; G10L 13/02; G06T 19/00; G02B 30/00

(52) U.S. Cl. CPC G06T 19/20; G06K 9/00335; G06K 9/00711; G06T 7/20; G06F 3/011; G10L 15/005; G10L 15/22; G10L 13/02; G06T 19/006; G02B 30/00; G06T 2207/30196; G06T 2219/2024

(57) ABSTRACT

An augmented reality hologram virtual aquarium system includes a control unit which includes a virtual fish video control unit for generating and controlling a virtual fish video, a display which displays a virtual fish video generated and transmitted by the video control unit, an aquarium management unit which is connected with the control unit and includes a history management unit related with the growth of the virtual fish and an equipment supply unit supplying equipment related with the growth of the virtual fish, and a user input unit which inputs the selection of the virtual fish and the growth activity through the control unit.

### BACKGROUND

The present invention relates to an augmented reality virtual aquarium system in which reality like as actually raising fishes may be felt and virtual fishes respond to owner's motion and voice.

In Korean Patent Registration No. 10-0799271, there is disclosed a digital aquarium which comprises a main body including a digital aquarium controller that performs a remote controller function for selecting a type of a fish, selecting publicity/advertisement video, selecting a clock screen image, replacing fishes in units of video, selecting video to be repeatedly reproduced, designating the number of selections of the video to be repeatedly reproduced, and inputting controlling of them, an MPEG player that includes a data/program storage unit that stores inputted images, videos, and signal processing programs and processes fish video so as to be displayed according to a setting of the digital aquarium controller, and a fish graphic video signal processing means including an image signal mixing processing unit that mixes a fish image, which has been processed to be displayed by the MPEG player, and a background image selected by a user, and outputs the mixed image, and a screen display control means; a display unit that is configured in the main body and displays a fish graphic image selected by the user; a user select signal input unit that controls a display content displayed on the display unit; and a data input/output unit that downloads and installs a program for controlling the fish graphic video signal or a fish movement.

Various aquatic organisms such as fish, amphibians, and reptiles live in the aquarium and may be seen by people, but a home aquarium having a small scale has long since emerged. Thus, even in the regular home, the aquarium is intended to be installed and maintained. However, it is difficult to manage the aquarium in the home, and the reason is that there is a need for continuous interests and learning of a manager such as fitting a growing condition according to characteristics of the fish and supplying food, and removal of sphagnum moss, replacement of water, or the like is inconvenient and frequently unsanitary to be performed by anybody in the general home, and may have an adverse effect on an aquarium ecosystem if things go wrong.

### SUMMARY OF THE INVENTION

An object of the present invention is to provide an augmented reality virtual aquarium system capable of selecting a type and a growth stage of a virtual fish by a user, managing a growth history and the like of the fish while performing a management of administering food, drugs, etc., like as an actual fish, and displaying the virtual fish of which appearance is changed according the growth history.

Further, another object of the present invention is to provide an augmented reality virtual aquarium system capable of showing the response of virtual fishes in response to a video motion, a touch motion, or a voice of the user and outputting a mutual conversation voice that responds to the owner's language.

According to an aspect of the present invention, there is provided an augmented reality hologram virtual aquarium system comprising a control unit which includes a virtual fish video control unit for generating and controlling a virtual fish video, a display which displays a virtual fish video generated and transmitted by the video control unit, an aquarium management unit which is connected with the control unit and includes a history management unit related with the growth of the virtual fish and an equipment supply unit supplying equipment related with the growth of the virtual fish, and a user input unit which inputs the selection of the virtual fish and the growth activity through the control unit.

The augmented reality virtual aquarium system may further include a hologram film generating a 3D stereoscopic shape as a video projected from the display.

The growth history management unit may separately manage an egg incubation stage, a fry stage, and an adult fish stage, and the equipment supply unit may supply fish-specific food, drugs, and exchange water.

The augmented reality virtual aquarium system may further include a camera photographing a video of a user, a video generation unit generating the video photographed by the camera, and an AI motion recognition unit recognizing a user's motion by analyzing the video provided from the video generation unit to transmit the recognized user's motion to the video control unit, wherein the video control unit may output a video in which the virtual fish responds to the recognized user's motion.

The augmented reality virtual aquarium system may further include a microphone sensing a user's sound, a voice file generation unit converting the sound sensed by the microphone to a file, and an AI voice recognition unit recognizing a user's language by analyzing the voice file generated by the voice file generation unit, wherein the control unit may further include a voice generation unit having a voice function of the virtual fish, and the voice generation unit may generate an output voice in which the virtual fish responds to the user's language recognized by the AI voice recognition unit to output the generated output voice to a speaker.

The control unit may further include a fish type selection unit, and the user input unit may be connected to the fish type selection unit to select a type and a growth stage of the virtual fish.

According to the present invention, it is possible to provide an augmented reality virtual aquarium system capable of selecting a type and a growth stage of a virtual fish by a user, managing a growth history and the like of the fish while performing a management of administering food, drugs, etc. like as an actual fish, and displaying the virtual fish of which appearance is changed according the growth history.

According to the present invention, it is possible to provide an augmented reality virtual aquarium system capable of showing the response of virtual fishes in response to a video motion, a touch motion, or voice of the user and outputting a mutual conversation voice that responds to the owner's language.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an overall schematic diagram of an augmented reality virtual aquarium system of the present invention.

### DETAILED DESCRIPTION OF THE PREFERRED EMBODIMENT

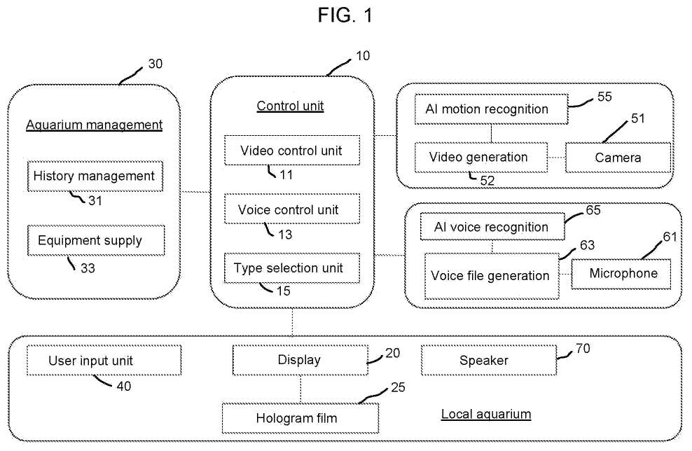

Hereinafter, an augmented reality hologram virtual aquarium system according to an embodiment of the present invention will be described in detail with reference to the accompanying drawings. FIG. 1 is an overall schematic diagram of an augmented reality virtual aquarium system of the present invention.

As illustrated in FIG. 1, an augmented reality virtual aquarium system according to an embodiment of the present invention includes a control unit 10, a display 20, an aquarium management unit 30, and a user input unit 40.

The control unit 10 includes a virtual fish video control unit 11 for generating and controlling a virtual fish video. The display 20 displays a virtual fish video generated and transmitted by the video control unit 11.

The control unit 10 may be configured in a processing device belonging to a local aquarium, but may also be provided on a remote server that may be connected through a wired/wireless communication network. In this case, the remote server includes and operates a content program that controls several local aquariums at different regions. The data of the control unit of the remote server transmits video and voice signals to the processing device (local control unit) provided in the local aquarium through communication.

The aquarium management unit 30 is connected with the control unit 10 and includes a history management unit 31 related with the growth of the virtual fish and an equipment supply unit 33 supplying equipment related with the growth of the virtual fish.

The aquarium management unit 30 may be configured in a processing device belonging to the local aquarium, but may also be provided on a remote server that may be connected through a wired/wireless communication network. In this case, the remote server includes and operates a content program that controls several to hundreds of local aquariums at different regions. The data of the control unit of the remote server transmits video and voice signals to the processing device (local control unit) provided in the local aquarium through communication. The data (video signal data and voice signal data of the user, request data through the user input unit, and management of the user) of the local aquarium are transmitted to the server through communication.

The user input unit 40 inputs the selection of the virtual fish and the growth activity through the control unit 10. The user input unit 40 is installed in the local aquarium. A signal of the user input unit 40 is transmitted to the control unit, but transmitted to the server through the local processing device (local control unit) when the control unit is installed in the remote server.

As illustrated in FIG. 1, the augmented reality virtual aquarium system according to an embodiment of the present invention further includes a hologram film 25 generating a 3D stereoscopic shape as a video projected from the display 20.

As illustrated in FIG. 1, in the augmented reality virtual aquarium system according to an embodiment of the present invention, the growth history management unit 31 separately manages an egg incubation stage, a fry stage, and an adult fish stage, and the equipment supply unit 33 supplies fish-specific food, drugs, exchange water, and the like.

As illustrated in FIG. 1, the augmented reality virtual aquarium system according to an embodiment of the present invention further includes a camera 51 photographing a video of a user, a video generation unit 52 generating the video photographed by the camera, and an AI motion recognition unit 55 recognizing a user's motion by analyzing the video provided from the video generation unit 52 to transmit the recognized user's motion to the video control unit 11. The video control unit 11 outputs a video in which the virtual fish responds to the recognized user's motion.

The local aquarium according to an embodiment of the present invention includes a touch sensor, a short-range monitoring sensor, a human sensing sensor, and the like, and the motion recognition unit 55 may transmit a user sensing signal of the sensors instead of a user's video signal to the video control unit 10. The video control unit 10 controls a response movement of the virtual fish based on the user sensing signal of the sensors.

As illustrated in FIG. 1, the augmented reality virtual aquarium system according to an embodiment of the present invention may include a microphone 61 sensing a user's sound, a voice file generation unit 62 converting the sound sensed by the microphone 61 to a file, and an AI voice recognition unit 65 recognizing a user's language by analyzing the voice file generated by the voice file generation unit 62. The control unit 10 further includes a voice generation unit 15 having a voice function of the virtual fish. The voice generation unit 15 generates an output voice in which the virtual fish responds to the user's language recognized by the AI voice recognition unit 65 to output the generated output voice to a speaker 70.

As illustrated in FIG. 1, in the augmented reality virtual aquarium system according to an embodiment of the present invention, the control unit 10 further includes a fish type selection unit 15, and the user input unit 40 is connected to the fish type selection unit 15 to select a type and a growth stage of the virtual fish.

Although the present invention has been described in connection with the preferred embodiments mentioned above, the scope of the present invention is not limited to these embodiments, and the scope of the present invention will include various modifications and modifications belonging to an equivalent range to the present invention as defined by the following claims.

The reference numerals described in the following claims are simply to assist in the understanding of the present invention, and do not affect the interpretation of the scope, and the scope of the present invention should not be interpreted by the reference numerals.

What is claimed is:

1. An augmented reality virtual aquarium system comprising:
a control unit which includes a virtual fish video control unit for generating and controlling a virtual fish video;
a display which displays a virtual fish video generated and transmitted by the video control unit;
an aquarium management unit which is connected with the control unit and includes a history management unit related with the growth of the virtual fish and an equipment supply unit supplying equipment related with the growth of the virtual fish; and
a user input unit which inputs the selection of the virtual fish and the growth activity through the control unit.

2. The augmented reality virtual aquarium system of claim 1, further comprising:
a hologram film generating a 3D stereoscopic shape as a video projected from the display.

3. The augmented reality virtual aquarium system of claim 1, wherein the growth history management unit separately manages an egg incubation stage, a fry stage, and an adult fish stage, and the equipment supply unit supplies fish-specific food, drugs, and exchange water.

4. The augmented reality virtual aquarium system of claim 1, further comprising:
a camera photographing a video of a user, a video generation unit generating the video photographed by the camera, and an AI motion recognition unit recognizing a user's motion by analyzing the video provided from the video generation unit to transmit the recognized user's motion to the video control unit,
wherein the video control unit outputs a video in which the virtual fish responds to the recognized user's motion.

5. The augmented reality virtual aquarium system of claim 4, further comprising:
a microphone sensing a user's sound,
a voice file generation unit converting the sound sensed by the microphone to a file, and
an AI voice recognition unit recognizing a user's language by analyzing the voice file generated by the voice file generation unit,
wherein the control unit further includes a voice generation unit having a voice function of the virtual fish, and
the voice generation unit generates an output voice in which the virtual fish responds to the user's language recognized by the AI voice recognition unit to output the generated output voice to a speaker.

6. The augmented reality virtual aquarium system of claim 1, wherein the control unit further includes a fish type selection unit, and the user input unit is connected to the fish type selection unit to select a type and a growth stage of the virtual fish.

7. The augmented reality virtual aquarium system of claim 1, wherein the virtual fish video control unit includes a fish video correction unit that corrects the fish video according to information of the history management unit by uploading the video from the video storage unit and a virtual fish video generation unit that generates a virtual fish video to the video corrected by the fish video correction unit.
